(19) United States
(12) Patent Application Publication
(10) Pub. No.: US 2010/0248593 A1
(43) Pub. Date: Sep. 30, 2010

(54) POLISHING SLURRY, PROCESS FOR PRODUCING THE SAME, POLISHING METHOD AND PROCESS FOR PRODUCING GLASS SUBSTRATE FOR MAGNETIC DISK

(75) Inventors: Tomohiro SAKAI, Tokyo (JP); Yoshihisa Beppu, Tokyo (JP); Hiroyuki Tomonaga, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Chiyoda-ku (JP)

(21) Appl. No.: 12/795,807

(22) Filed: Jun. 8, 2010

Related U.S. Application Data
(63) Continuation of application No. PCT/JP09/66186, filed on Sep. 16, 2009.

(30) Foreign Application Priority Data
Oct. 1, 2008 (JP) 2008-256103

(51) Int. Cl. B24B 1/00; C09C 1/68; C09K 3/14

(52) U.S. Cl. 451/36; 51/309

(57) ABSTRACT

The present invention provides a process for producing a polishing slurry, which achieves high-speed polishing of a principal plane of a glass substrate even when ceria crystal fine particles or ceria-zirconia solid solution crystal fine particles are employed.

A process for producing a polishing slurry having a pH of from 2 to 7, comprising preparing a polishing slurry liquid containing abrasive particles, a dispersing agent and water, wherein the abrasive particles comprise ceria particles or ceria-zirconia solid solution particles and the dispersing agent comprises 2-pyridine carboxylic acid or glutamic acid; dispersing the abrasive particles of the polishing slurry liquid so that the reduction ratio of the crystallite diameter of the abrasive particles becomes at most 10%; subsequently adding water; and adding the same dispersing agent as the above dispersing agent.

### TECHNICAL FIELD

The present invention relates to a polishing method of e.g. a principal plane of a glass substrate for a magnetic disk containing SiO₂, a polishing slurry to be suitably employed for such a polishing method, and a process for producing such a polishing slurry.

### BACKGROUND ART

Demand for high recording density of magnetic disks to be mounted on information processing devices such as hard disk drives is increasing in recent years, and under these circumstances, glass substrates are now widely used instead of conventional aluminum substrates.

However, demand for high recording density is increasingly high, and to meet such a demand, various proposals have been made with respect to a method of polishing the principal plane of the glass substrate with high precision (for example, Patent Document 1).

### PRIOR ART

### Patent Document

Patent Document 1: JP-A-2008-105168

### OUTLINE OF THE INVENTION

### Problems to be Solved by the Invention

The invention disclosed in Patent Document 1, which is proposed as a method of polishing the principal plane of the glass substrate for a magnetic disk (hereinafter sometimes referred to simply as a glass substrate) with high precision, is to polish the principal plane with high precision by means of ceria crystal fine particles produced by a flux method.

Generally, the polishing rate by ceria particles is higher than the polishing rate by colloidal silica. However, in a polishing of a glass substrate employing ceria crystal fine particles to obtain high precision surface quality, the polishing rate is not sufficiently high as compared with a polishing employing colloidal silica since the size of particles is small, and this is a problem of this method.

It is an object of the present invention to provide a polishing method which achieves polishing of a principal plane of a glass substrate with high polishing rate even in a case of employing ceria crystal fine particle or ceria-zirconia solid solution crystal fine particles; a polishing slurry suitable for such a polishing method; and a process for producing such a polishing slurry.

### Means for Solving the Problems

The present invention provides a process for producing a polishing slurry having a pH of from 2 to 7, comprising preparing a polishing slurry liquid containing abrasive particles, a dispersing agent and water, wherein the abrasive particles comprise ceria particles or ceria-zirconia solid solution particles and the dispersing agent comprises 2-pyridine carboxylic acid or glutamic acid; dispersing the abrasive particles of the polishing slurry liquid so that the reduction ratio of the crystallite diameter of the abrasive particles becomes at most 10%; subsequently adding water; and adding the same dispersing agent as the above dispersing agent.

Further, the present invention provides a process for producing a polishing slurry having a pH of from 2 to 7, comprising preparing a polishing slurry liquid containing abrasive particles, a dispersing agent and water, wherein the abrasive particles comprise ceria particles or ceria-zirconia solid solution particles and the dispersing agent comprises 2-pyridine carboxylic acid or glutamic acid; dispersing the abrasive particles of the polishing slurry liquid by a wet jet mill; subsequently adding water; and adding the same dispersing agent as the above dispersing agent.

Further, the present invention provides a polishing slurry produced by the above process for producing a polishing slurry.

Further, the present invention provides a polishing method of polishing an object to be polished having a surface to be polished containing SiO₂, by employing the above polishing slurry.

Further, the present invention provides a process for producing a glass substrate for a magnetic disk containing SiO₂, which uses the polishing method as defined in the above 13 or 14 for polishing of the principal plane of the glass substrate.

The present inventors have conducted extensive studies as to dispersing agents, additives after dispersion and dispersion methods in order to achieve the above objects. As a result, they have discovered that it is possible to achieve a polishing with high polishing rate by conducting a dispersion method wherein the crystallite diameter of abrasive particles obtained by an X ray diffraction measurement and calculated by a Scherrer method does not decrease or does not decrease significantly; employing a dispersing agent and an additive that tend to form a status wherein the abrasive particles have a positive potential and the object to be polished has a negative potential in a predetermined pH range; and conducting a polishing in the pH range. Thus they achieved the present invention.

### Effects of the Invention

By the present invention, it is possible to polish e.g. a principal plane of a glass substrate for a magnetic disk with high polishing rate by employing ceria crystal fine particles or ceria-zirconia solid solution crystal fine particles.

### MODES FOR CARRYING OUT THE INVENTION

According to the method for producing a glass substrate for a magnetic disk of the present invention, a glass substrate is produced usually by means of the following steps. Namely, a circular hole is put at the center of a circular glass plate, and chamfering, lapping of the principal plane and mirror polishing of the edge surface are sequentially carried out. Then, such circular glass plates thus processed are laminated, inner peripheral edge surfaces are etched, and the etched inner peripheral edge surfaces are coated with, for example, a polysilazane compound-containing liquid by e.g. spraying, followed by firing to form a coating film (protective coating film) on the inner peripheral edge surfaces. Then, the principal plane of each circular glass plate, on the inner peripheral edge surface of which a coating film is formed, is polished to be a flat and smooth surface, thereby to obtain a glass substrate for a magnetic disk.

The production method of the present invention is not limited to the above. For example, brush polishing may be applied to the inner peripheral edge surfaces instead of formation of a protective coating film on the inner peripheral edge surfaces; the principal plane lapping step may be divided into a coarse lapping step and a precise lapping step, and a shape-processing step (perforation at the center of the circular glass plate, chamfering and polishing of the edge surface) may be provided between the coarse and precise lapping steps, or chemical tempering step may be provided after the principal plane polishing step. For production of a glass substrate having no circular hole at the center, perforation at the center of the circular glass plate is unnecessary.

The principal plane lapping is carried out usually by using alumina abrasive particles or metal oxide abrasive particles including alumina having an average particle size of from 6 to 8 μm.

The lapped principal plane is polished usually as follows. First, the principal plane is polished by means of a slurry containing cerium oxide having an average particle size of from 0.9 to 1.8 μm and a urethane polishing pad. The loss of the plate thickness (removal amount) is typically from 30 to 40 μm.

Then, the principal plane is polished by using the polishing method of the present invention. As a pad, e.g. a polishing pad made of an urethane is employed.

The abrasive particles in the polishing slurry of the present invention is usually ceria particles or ceria-zirconia solid solution particles in order to increase the polishing rate or the polishing precision.

The abrasive particles to be used for the polishing slurry liquid, that are ceria particles or ceria-zirconia solid solution particles, (hereinafter it may be simply referred to as abrasive particles) has a crystallite dimension D_{C} of preferably from 5 to 100 nm. If it is less than 5 nm, polishing may not progress sufficiently. It is more preferably at least 10 nm, typically at least 20 nm. If it exceeds 100 nm, a scratch may be caused. It is more preferably at most 50 nm, typically at most 40 nm. Here, the crystallite diameter in this specification is calculated from a spread of a diffraction peak measured by an X-ray diffraction apparatus, by using a Scherrer formula.

The average primary particle size D_{A} of the abrasive particles employed in the polishing slurry liquid is preferably from 5 to 100 nm. If it is less than 5 nm, the polishing rate may decrease. It is more preferably at least 10 nm, typically at least 20 nm. If it exceeds 100 nm, a scratch may be formed on a surface to be polished. It is more preferably at most 50 nm, typically at most 40 nm. Here, the average primary particle size in this specification is obtained by conducting a specific surface area measurement by a BET method and calculated by using a perfect-sphere approximation.

The ratio of the average primary particle size D_{A} to the above crystallite diameter D_{C}, that is a particle size ratio D_{A}/D_{C}, is preferably from 0.8 to 2.5. It is considered that when it is at least 0.8, formation of single crystal shape is promoted to decrease crystal lattice defects, and as a result, it becomes possible to always maintain an active portion contributing to improve polishing rate on an outer surface of each polishing particle, thereby to conduct polishing at a high polishing rate. The particle size ratio D_{A}/D_{C} is more preferably at least 1.0. Further, it is considered that when the ratio D_{A}/D_{C} is at most 2.5, it becomes easy to maintain the shape of the oxide fine particles into a single crystal shape, and as a result, it is possible to suppress generation of scratches due to intermixture of polycrystal coarse particles. It is more preferably at most 2.0, particularly preferably at most 1.8.

The abrasive particles may be produced by a known method such as a flux method, a hydrothermal method, a solid phase reaction method, a sol-gel method or a gas phase method.

Among these, a flux method and a solid phase reaction method are particularly preferred since particles having high crystallinity can be obtained and such a method is effective for obtaining oxide fine particles having a particle size ratio D_{A}/D_{C} within a range of from 0.8 to 2.5 and maintaining the shape of single crystal.

Among flux methods, a method called glass-crystallization method of crystallizing oxide particles in a glass matrix followed by removing the glass matrix, is particularly preferred since it is possible to obtain crystalline fine particles having a small particle size and maintaining the shape of single crystal. Namely, a component to be precipitated as oxide fine particles is dissolved in a glass matrix molten liquid, and the molten liquid is quenched to be vitrified and subjected to a heat process again to precipitate the oxide fine particles in the glass matrix in the method. The precipitated oxide fine particles are recovered by dissolving the glass matrix by using an appropriate chemical. The above glass matrix may be of borate type, phosphate type, silicate type and so on, and for the reasons of e.g. melting property, easiness of production of a complex compound with the objective oxide and easiness of removal of the glass matrix, a glass matrix of borate type is preferably employed.

When the abrasive particles are produced by the above glass crystallization method, the abrasive particles is preferably produced by a process for producing a polishing slurry, wherein the abrasive particles of the polishing slurry liquid is produced by a process comprising a step of obtaining a melt containing, as represented by mol % based on oxide, from 5 to 50% of CeO₂ or a mixture of CeO₂ and ZrO₂, from 10 to 50% of RO (R is at least one type selected from the group consisting of Mg, Ca, Sr and Ba), and from 30 to 75% of B₂O₃; a step of quenching the melt to obtain an amorphous material; a step of precipitating CeO₂ crystals or ceria-zirconia solid solution crystals from the amorphous material to obtain a crystallized product; and a step of separating the CeO₂ crystals or the ceria-zirconia solid solution crystals from the obtained crystallized product, in this order. By this process, it is possible to easily obtain ceria crystal fine particles or ceria-zirconia crystal fine particles excellent in the composition and the uniformity of particle size and having a small particle size.

The temperature in the step of obtaining the melt is preferably from 1,200 to 1,600° C., more preferably from 1,400 to 1,550° C. Further, the time of the step is preferably from 1 to 6 hours including a temperature-rising time. The cooling speed in the step of quenching the melt to obtain an amorphous material is preferably from 10³ to 10⁶° C./sec, more preferably from 10⁴ to 10⁶° C./sec. Further, in the step of separating the ceria crystals or ceria-zirconia solid solution crystals from the obtained crystallized product, it is preferred to dissolve the glass matrix of the obtained crystallized product by using an appropriate chemical such as an inorganic acid such as nitric acid or hydrochloric acid or an organic acid at from 20 to 90° C. for 1 to 100 hours, followed by separating the ceria crystals or the ceria-zirconia solid solution crystals by a method such as filtration, drying or centrifugation separation.

At this time, it is preferred to carry out the step of separating the ceria crystals or the ceria-zirconia solid solution crystals from the amorphous material in the atmospheric air at from 600 to 850° C. By carrying out the crystallization step at a temperature of at least 600° C., it is possible to sufficiently precipitate the ceria crystals or the ceria-zirconia solid solution crystals. Further, by carrying out the crystallization step at a temperature of at most 850° C., it becomes easy to obtain ceria crystal fine particles or ceria-zirconia crystal fine particles having a particle size ratio D_{A}/D_{C} of from 0.8 to 2.5 and having a shape of single crystal. It is more preferred to carry out the crystallization step in the atmospheric air at a temperature of from 650 to 800° C., particularly preferably from 680 to 800° C. Here, since the higher the heating temperature, the D_{C} of the precipitated crystal tends to be larger, the heating temperature may be selected according to a desired crystallite diameter. The time of this crystallization step is preferably from 0.5 to 128 hours, more preferably from 2 to 32 hours.

In the polishing slurry liquid, the abrasive particles are dispersed so that the reduction rate of D_{C} of the abrasive particles becomes at most 10%, or dispersed by a wet jet mill. Here, also when the abrasive particles are dispersed by a wet jet mill, the dispersion is preferably conducted so that the reduction ratio of D_{C} of the abrasive particles is at most 10%. The reduction ratio of D_{C} of the abrasive particles is preferably at most 2%, particularly preferably 0%.

A method of dispersing the abrasive particles in the polishing slurry liquid so that the reduction ratio of D_{C} of the abrasive particles becomes at most 10%, may be any common dispersing method so long as it uses no pulverized medium, and it may, for example, be a known wet jet mill or an ultrasonic dispersion method.

Here, the wet jet mill is a method of mixing a suspension or a solution without using a pulverized medium as differently from e.g. a ball mill, and in the wet jet mill, e.g. a slurry, a suspension or solution are collided with each other at a high speed to achieve mixture and dispersion in a short time.

As a wet jet mill for slurry, there are known one which jets out high pressure slurries from at least two nozzles and make them collide with each other so that particles are mutually collided, to pulverize and disperse agglomerates by a kinetic energy of collision (Star Burst (product name) manufactured by Sugino Machine Limited), and one which plunges a slurry so as to pass through a slit at a high speed to thereby pulverize and disperse agglomerates by a shearing force (Nanomiser (product name) manufactured by Yoshida Kikai Co., Ltd.).

Further, the ultrasonic dispersion method is a method of pulverizing and dispersing agglomerates by an energy of ultrasonic waves.

Here, differently from such a medialess dispersion, in a dispersion using a media such as a ball mill, a shearing force applied to particles are so large that particles are destroyed at the same time as dispersion and D_{C} decreases by more than 10%. As a result, the polishing rate tends to decrease, such being not preferred.

It is not clear why the polishing rate decreases when D_{C} decreases by more than 10%, but the inventors consider that along with destruction of crystals, particle surfaces are also damaged to form inactive layers to prevent polishing.

The polishing slurry liquid contains a dispersing agent comprising 2-pyridine carboxylic acid or glutamic acid in order to promote dispersion in the above-mentioned dispersion method to reduce the dispersion particle size (a median diameter being a cumulative 50% particle size of a particle size distribution) of abrasive particles in the slurry, and to inhibit generation of scratches during polishing.

The content of the dispersing agent in the polishing slurry liquid is preferably from 0.1 to 5 mass %. If it is less than 0.1 mass %, the effect of promoting the dispersion is small. It is preferably at least 0.15 mass %. If it exceeds 5 mass %, agglomeration may occur.

To the dispersion obtained by dispersing the polishing slurry liquid as described above, water is added to adjust the concentration of the abrasive particles.

Further, to the dispersion, the same dispersing agent as the above dispersing agent is added. Namely, when the above dispersing agent is 2-pyridine carboxylic acid, 2-pyridine carboxylic acid is added to the dispersion, and when the above dispersing agent is glutamic acid, glutamic acid is added to the dispersion.

When the same dispersing agent as described above is added to the dispersion, it is possible to increase the zeta potential of the abrasive particles, whereby a state that the abrasive particles are charged to be positive and the glass substrate is charged to be negative under a pH condition between pH2 that is an isopotential point of the glass substrate and pH7 that is an isopotential point of the abrasive particles. Accordingly the interaction between the abrasive particles and the glass substrate becomes strong and it becomes possible to increase the polishing rate.

Further, if the same dispersing agent as the above dispersing agent is not added to the dispersion, a pot life, that is a lifetime of the polishing slurry, may become shorter, or, the abrasive particles tend to be agglomerated.

The content of the same dispersing agent as the above dispersing agent, this is added at this time, is preferably from 0.01 to 2 mass % in terms of the content in the polishing slurry. If it is less than 0.01 mass %, a sufficient polishing rate may not be obtained. It is more preferably at least 0.03 mass %, particularly preferably at least 0.3 mass %. If it exceeds 2 mass %, agglomeration may occur. It is more preferably at most 1.5 mass %, particularly preferably at most 1 mass %.

Here, in order to remove agglomerated particles or coarse particles in the dispersion, a filtering treatment using a filter or centrifugation separation may be applied.

The pH of a polishing slurry thus prepared is adjusted to from 2 to 7. If it is less than 2, agglomeration tends to occur. It is preferably at least 3. Also if it exceeds 7, agglomeration tends to occur or the ζ potential of the abrasive particles tends to be negative. It is preferably at most 5.

Here, as a pH adjusting agent or a pH buffering agent, an inorganic acid such as nitric acid, an organic acid such as succinic acid or citric acid, a quarternary ammonium hydroxide such as tetramethylammonium hydroxide, alkali metal hydrate, etc. may be suitably employed.

The content of the abrasive particles in the polishing slurry may be appropriately selected considering the polishing rate, the dispersion uniformity, the dispersion stability etc., and usually it is within a range of from 0.1 to 40 mass %. If the content is less than 0.1 mass %, polishing may not progress sufficiently. It is preferably at least 0.5 mass %. If it exceeds 40 mass %, the viscosity of the slurry becomes too high, or it becomes difficult to sufficiently maintain the dispersion property, whereby handling of the polishing slurry becomes difficult. It is preferably at most 20 mass %, more preferably at most 10 mass %.

The median diameter of the polishing slurry is preferably from 10 to 300 nm. If it is less than 10 nm, the polishing may not progress sufficiently. It is more preferably at least 20 nm. If it exceeds 300 nm, a scratch may be caused. It is more preferably at most 200 nm.

The polishing slurry of the present invention contains abrasive particles, water, 2-pyridine carboxylic acid or glutamic acid, and besides, the polishing slurry may contain other components within the range not departing from the object of the present invention.

For example, the polishing slurry may contain the above-described pH adjusting agent or pH buffering agent as the case requires, the polishing slurry may contain e.g. a polyethylene glycol or a polyethylene imine in order to adjust the viscosity of the slurry, and the polishing slurry may contain a medium soluble to water or a medium having a high relative dielectric constant miscible with water, such as methanol, ethanol, propanol, ethylene glycol or propylene glycol. Further, the polishing slurry may contain an oxidant, a deoxidant, a resin functioning as a stabilizer of fine particles, a dishing-preventing agent, an erosion-preventing agent, etc.

In the polishing method of the present invention, since the polishing slurry contains 2-pyridine carboxylic acid or glutamic acid, usually, the ζ potential of the abrasive particles of the polishing slurry is positive, and the ζ potential of an object to be polished becomes negative. In this condition, an interaction with the abrasive particles and the object becomes strong, such being preferred. The ζ potential of the abrasive particles is preferably from 30 to 50 mV, the ζ potential of the object is preferably from −50 to −10 mV.

### EXAMPLES

Now, the present invention will be further described with reference to Examples and Comparative Examples, but the present invention is by no means limited to these Examples.

### Example 1

Cerium oxide (Ceria, CeO₂), barium carbonate (BaCO₃) and boron oxide (B₂O₃) were weighed so that they became, as represented by mol %, 33.4%, 13.3% and 53.3%, respectively based on CeO₂, BaO and B₂O₃, respectively, they were well wet-mixed by an automatic mortar by using a small amount of ethanol to obtain a mixture, and the mixture was dried to produce a raw material mixture.

The obtained raw material mixture was put in a platinum container (the platinum contains 10 wt % of rhodium) having a nozzle for dripping a molten liquid, the raw material mixture in the platinum container was heated in an electric furnace having a heating element of molybdenum silicide at 1,350° C. for 2 hours to be completely melted. Subsequently, while the nozzle portion was heated, the molten liquid was dripped between a pair of rolls (roll diameter: 150 mm, roll rotation speed: 300 rpm, roll surface temperature: 30° C.) disposed under the electric furnace, to obtain a flake-form solid product. The obtained flake-form solid product shows transparent, and it was confirmed to be an amorphous material by a powder X-ray diffraction.

The amorphous material was subjected to a dry ball mill pulverization by using zirconia balls of 5 mmφ for 8 hours to obtain a pulverized product.

The obtained pulverized product was heated at 700° C. for 32 hours so that ceria crystals are precipitated.

Subsequently, the crystallized product was added to 1 mol/L of acetic acid aqueous solution maintained at 80° C., the solution was stirred for 12 hours, and subjected to centrifugation separation, water rinse and drying to obtain ceria crystal fine particles (hereinafter it is also referred to as fine particles A) as abrasive particles.

The mineral phase of the fine particles A was identified by an X-ray diffract meter. As a result, the fine particles A were cubic crystals and their diffraction peaks agreed with a known diffraction peak of CeO₂ (JCPDS card No.: 34-0394), and the fine particles A were found to be particles with high crystallinity consisting of a CeO₂ single phase. Further, the crystallite diameter of the fine particles A was 31 nm, the average primary particle size was 32 nm, and accordingly, the ratio “crystallite diameter:average primary particle size” was 1:1.0.

Here, the crystallite diameter was calculated from a spread of a diffraction line measured by an X-ray diffract meter (model: RINT2500) manufactured by Rigaku Corporation, by using Scherrer's formula. The average primary particle size was calculated from a specific surface area obtained by a multi-point BET method by using a specific surface area measurement apparatus (model: ASAP2020) manufactured by Micromeritics Instrument Corporation with perfect-sphere approximation.

Further, 450 g of fine particles A, 1,036.5 g of purified water and 13.5 g of 2-pyridine carboxylic acid, that is a dispersing agent, were blended to obtain a polishing slurry liquid (content of dispersing agent=0.9 mass %).

The polishing slurry liquid was subjected to a dispersion treatment by using a wet jet mill apparatus (model: HJP-25005) manufactured by Sugino Machine Limited to obtain a dispersion A. The crystallite diameter of the fine particles of the dispersion A was 31 nm, and the reduction of the crystallite diameter was 0%.

Next, the concentration of the fine particles A in the dispersion A was adjusted by purified water so that the concentration became 2 mass %. The dispersion A was mixed with a 2-pyridine carboxylic acid aqueous solution of 0.4 mass % concentration so that their mass ratio became 1:1, and stirred to be mixed to obtain a polishing slurry 1. Here, the content of the 2-pyridine carboxylic acid added to the dispersion A was 0.2 mass % in terms of the concentration in the polishing slurry 1, and the content of the abrasive particles in the polishing slurry 1 was 1 mass %.

The median diameter in the polishing slurry 1 was 148 nm, its pH was 3.6, the zeta potential of the fine particles being abrasive particles was 38 mV, and the zeta potential of the glass substrate was −13 mV.

Here, the median diameter was obtained by using a particle size distribution measurement apparatus (model: UPA-ST150) manufactured by Nikkiso Co., Ltd., and the zeta potential was measured by using a zeta potential measurement apparatus (model: ELS-8000) manufactured by Otsuka Electronics Co., Ltd. Then, by using the polishing slurry 1, polishing of a silicate glass substrate was conducted by a small-sized polishing machine (model: FAM12BS) manufactured by Speedfam Co., Ltd. The polishing rate was 0.116 μm/min. Here, the polishing rate is preferably at least 0.1 μm/min.

### Example 2

The concentration of the fine particles A in the dispersion A was adjusted by purified water so that the concentration became 2 mass %. The dispersion A was mixed with a 1 mass % 2-pyridine carboxylic acid aqueous solution so that the mass ratio became 1:1, to obtain a polishing slurry 2. Here, the content of the 2-pyridine carboxylic acid added to the dispersion A was 0.5 mass % in terms of the content in the polishing slurry 2, and the content of the abrasive particles in the polishing slurry 2 was 1 mass %.

The median diameter of the polishing slurry 2 was 148 nm, the pH was 3.3, the zeta potential of the fine particles being abrasive particles was 38 mV, and the zeta potential of the glass substrate was −11 mV.

Then, the polishing rate measured in the same manner as Example 1 by using the polishing slurry 2 was 0.135 μm/min.

### Example 3

The concentration of the fine particles A in the dispersion A was adjusted by purified water so that the concentration became 2 mass %, and the dispersion A was mixed with 2 mass % 2-pyridine carboxylic acid aqueous solution so that the mass ratio became 1:1, to obtain a polishing slurry 3. Here, the content of the 2-pyridine carboxylic acid added to the dispersion A was 1 mass % in terms of the content in the polishing slurry 3, and the content of the abrasive particles in the polishing slurry 3 was 1 mass %.

The median diameter of the polishing slurry 3 was 145 nm, the pH was 3.2, the zeta potential of the fine particles being abrasive particles was 39 mV, and the zeta potential of the glass substrate was −14 mV.

Then the polishing rate with the polishing slurry 3 measured in the same manner as Example 1 was 0.119 μm/min.

### Example 4

450 g of fine particles A, 1,045.5 g of purified water and 4.5 g of glutamic acid being a dispersing agent, were mixed to obtain a polishing slurry liquid (content of dispersing agent=0.3 mass %).

The polishing slurry liquid was subjected to a dispersion treatment by using a wet jet mill apparatus (model: HJP-25005) manufactured by Sugino Machine Limited, to obtain a dispersion B. The crystallite diameter of the fine particles in the dispersion B was 31 nm, and reduction of the crystallite diameter was 0%.

The concentration of the fine particles A in the dispersion B was adjusted by purified water so that the content became 2 mass %, and the dispersion B was mixed with 1 mass % glutamic acid aqueous solution so that the mass ratio became 1:1, to obtain a polishing slurry 4. Here, the content of the 2-pyridine carboxylic acid added to the dispersion B was 0.5 mass % in terms of the content in the polishing slurry 4, and the content of the abrasive particles in the polishing slurry 4 was 1 mass %.

The median diameter of the polishing slurry 4 was 137 nm, the pH was 3.1, and the zeta potential of the fine particles being abrasive particles was 44 mV, and the zeta potential of the glass substrate was −45 mV.

Then, the polishing rate with the polishing slurry 4 measured in the same manner as Example 1 was 0.125 μm/min.

### Example 5

Cerium oxide, barium carbonate, calcium carbonate (CaCO₃) and boron oxide were weighed so that they became, as represented by mol %, 17.8%, 4.4%, 35.6% and 42.2%, respectively based on CeO₂, BaO, CaO and B₂O₃, respectively. They were well wet-mixed together with a small amount of ethanol by using an automatic mortar, and dried to obtain a raw material mixture.

The obtained raw material mixture was e.g. melted in the same manner as Example 1 to obtain a flake-formed solid product, and it was pulverized.

The obtained pulverized product was heated at 800° C. for 8 hours so that ceria-zirconia solid solution crystals were precipitated.

Subsequently, the crystallized product was added into a 1 mol/L acetic acid aqueous solution maintained at 80° C., the solution was stirred for 12 hours, and subjected to centrifugation separation, water rinse and drying, to obtain ceria-zirconia solid solution crystal fine particles (hereinafter it may also be referred to a fine particles B).

The crystallite diameter of the fine particles B was 22 nm, its average primary particle size was 25 nm, and the ratio “crystallite diameter:average primary particle size” was 1:1.1.

Further, 450 g of fine particles B, 1,036.5 g of purified water and 13.5 g of 2-pyridine carboxylic acid being a dispersing agent, were mixed to obtain a polishing slurry liquid (the content of the dispersing agent=0.9 mass %).

The polishing slurry liquid was subjected to a dispersion treatment by using a wet jet mill apparatus (model: HJP-25005) manufactured by Sugino Machine Limited, to obtain a dispersion C. The crystallite diameter of the fine particles in the dispersion C was 22 nm, and the reduction of the crystallite diameter was 0%.

Next, the concentration of the fine particles B in the dispersion C was adjusted by adding purified water so that the concentration became 1 mass %, and the dispersion C was mixed with 1 mass % 2-pyridine carboxylic acid aqueous solution so that the mass ratio became 1:1, to obtain a polishing slurry 5. Here, the content of the 2-pyridine carboxylic acid added to the dispersion C was 0.5 mass % in terms of the content in the polishing slurry 5, and the content of the abrasive particles in the polishing slurry 5 was 1 mass %.

The median diameter of the polishing slurry 5 was 132 nm, the pH was 3.3, the zeta potential of the fine particles being abrasive particles was 43 mV, and the zeta potential of the glass substrate was −12 mV.

Then, the polishing rate with the polishing slurry 5 measured in the same manner as Example 1 was 0.110 μm/min.

### Comparative Example 1

A dispersion D was obtained in the same manner as Example 1 except that 450 g of the fine particles A, 1,047.7 g of purified water and 2.3 g of polyammonium acrylate were mixed and a dispersion treatment was carried out. The crystallite diameter of the fine particles after the dispersion was 31 nm, and reduction of the crystallite diameter was 0%.

Next, the concentration of the fine particles in the dispersion D was adjusted by purified water so that the concentration became 3 mass %, to obtain a polishing slurry 11. The median diameter of the polishing slurry 11 was 131 nm, and the pH was 8.1.

Further, polishing was carried out in the same manner as Example 1 by using the polishing slurry 11. The polishing rate was 0.055 μm/min, the zeta potential of the fine particles was −38 mV, and the zeta potential of the glass substrate was −42 mV.

### Comparative Example 2

The concentration of the fine particles in the dispersion D was adjusted by purified water so that the concentration became 6 mass %, and the dispersion D was mixed with 1 mass % 2-pyridine carboxylic acid aqueous solution so that the weight ratio became 1:1, to obtain a polishing slurry 12. The median diameter of the polishing slurry 12 was 480 nm, and the pH was 7.0.

Further, by using the polishing slurry 12, polishing was carried out in the same manner as Example 1. The polishing rate was 0.034 μm/min, the zeta potential of the fine particles was −46 mV, and the zeta potential of the glass substrate was −43 mV.

### Comparative Example 3

A dispersion E was obtained in the same manner as Example 1 except that 450 g of the fine particles B, 1,047.7 g of purified water and 2.3 g of polyammonium acrylate were mixed and a dispersion treatment was carried out. The crystallite diameter of the fine particles after the dispersion was 22 nm, and reduction of the crystallite diameter was 0%.

Next, the concentration of the fine particles in the dispersion E was adjusted by purified water so that the content became 3 mass %, to obtain a polishing slurry 13. The median diameter of the polishing slurry 13 was 125 nm, and the pH was 8.1.

Further, polishing was carried out in the same manner as Example 1 by using the polishing slurry 13. The polishing rate was 0.069 μm/min, the zeta potential of the fine particles was −40 mV, and the zeta potential of the glass substrate was −45 mV.

### Comparative Example 4

450 g of the fine particles A, 1,036.5 g of purified water and 13.5 g of 2-pyridine carboxylic acid were mixed to obtain a mixture, and the mixture was subjected to a dispersion treatment by a ball mill employing zirconia balls of 0.5 mm in diameter for 72 hours, to obtain a dispersion F. The crystallite diameter of the fine particles after the dispersion was 25 nm, and reduction of the crystallite diameter was 19%.

Next, the concentration of the fine particles in the dispersion F was adjusted by purified water so that the concentration of the fine particles became 2 mass %, and the dispersion F was mixed with 1 mass % 2-pyridine carboxylic acid aqueous solution so that the weight ratio became 1:1, to obtain a polishing slurry 14. The median diameter of the polishing slurry 14 was 99 nm, and the pH was 3.8.

Further, by using the polishing slurry 14, polishing was carried out in the same manner as Example 1. The polishing rate was 0.040 μm/min, the zeta potential of the fine particles was 41 mV, and the zeta potential of the glass substrate was −8 mV.

### Comparative Example 5

450 g of the fine particles A, 1,047.7 g of purified water and 2.3 g of polyammonium acrylate were mixed to obtain a mixture, and the mixture was subjected to a dispersion treatment by a ball mill employing zirconia balls of 0.5 mm in diameter for 72 hours, to obtain a dispersion G. The crystallite diameter of the fine particles after the dispersion was 25 nm, and reduction of the crystallite diameter was 19%.

Next, the concentration of the fine particles in the dispersion G was adjusted by purified water so that the concentration of the fine particles became 3 mass %, to obtain a polishing slurry 15. The median diameter of the polishing slurry 15 was 72 nm, and the pH was 8.2.

Further, by using the polishing slurry 15, polishing was carried out in the same manner as Example 1. The polishing rate was 0.005 μm/min, the zeta potential of the fine particles was −39 mV, and the zeta potential of the glass substrate was −42 mV.

### Comparative Example 6

A polishing slurry 16 was obtained, wherein the concentration of a colloidal silica having a particle size of 30 nm was adjusted to 15.7 mass % and the pH was adjusted to 2 by nitric acid.

Further, by using the polishing slurry 16, polishing was carried out in the same manner as Example 1. The polishing rate was 0.040 μm/min, the zeta potential of the fine particles was −2 mV, and the zeta potential of the glass substrate was −4 mV.

### Comparative Example 7

450 g of the fine particles A and 1,050 g of purified water were mixed to obtain a mixture, and the mixture was subjected to a dispersion treatment by using a wet jet mill apparatus (model: HJP-25005) manufactured by Sugino Machine Limited. An obtained slurry tended to sediment and was not dispersed.

### Comparative Example 8

450 g of the fine particles A, 1,045.5 g of purified water and 4.5 g of glycine were mixed to obtain a mixture, and the mixture was subjected to a dispersion treatment by using a wet jet mill apparatus (model: HJP-25005) manufactured by Sugino Machine Limited. An obtained slurry tended to sediment and was not dispersed.

### Comparative Example 9

450 g of the fine particles A, 1,045.5 g of purified water and 4.5 g of 2,3-pyridine carboxylic acid were mixed to obtain a mixture, and the mixture was subjected to a dispersion treatment by using a wet jet mill apparatus (model: HJP-25005) manufactured by Sugino Machine Limited. An obtained slurry tended to sediment and was not dispersed.

### Comparative Example 10

The concentration of the fine particles A in the dispersion A was adjusted by purified water so that the concentration became 1 mass %, to obtain a polishing slurry 17. The median diameter of the polishing slurry 17 was 148 nm, the pH was 4.2, the zeta potential of the fine particles being abrasive particles was 25 mV, and the zeta potential of the glass substrate was −18 mV.

Then, by using the polishing slurry 17, polishing rate was measured in the same manner as Example 1, and it was 0.037 μm/min.

### Comparative Example 11

The concentration of the fine particles A in the dispersion B was adjusted by purified water so that the concentration became 1 mass %, to obtain a polishing slurry 18. The median diameter of the polishing slurry 18 was 141 nm, the pH was 3.8, the zeta potential of the fine particles being abrasive particles was 17 mV, and the zeta potential of the glass substrate was −35 mV.

Then, by using the polishing slurry 18, polishing rate was measured in the same manner as Example 1, and it was 0.031 μm/min.

### INDUSTRIAL APPLICABILITY

The present invention is applicable to polishing of a glass substrate of e.g. a magnetic disk, an optical disk, a semiconductor device or polishing of e.g. an optical lens.

The entire disclosure of Japanese Patent Application No. 2008-256103 filed on Oct. 1, 2008 including specification, claims and summary is incorporated herein by reference in its entirety.

What is claimed is:

1. A process for producing a polishing slurry having a pH of from 2 to 7, comprising preparing a polishing slurry liquid containing abrasive particles, a dispersing agent and water, wherein the abrasive particles comprise ceria particles or ceria-zirconia solid solution particles and the dispersing agent comprises 2-pyridine carboxylic acid or glutamic acid; dispersing the abrasive particles of the polishing slurry liquid so that the reduction ratio of the crystallite diameter of the abrasive particles becomes at most 10%; subsequently adding water; and adding the same dispersing agent as the above dispersing agent.

2. A process for producing a polishing slurry having a pH of from 2 to 7, comprising preparing a polishing slurry liquid containing abrasive particles, a dispersing agent and water, wherein the abrasive particles comprise ceria particles or ceria-zirconia solid solution particles and the dispersing agent comprises 2-pyridine carboxylic acid or glutamic acid; dispersing the abrasive particles of the polishing slurry liquid by a wet jet mill; subsequently adding water; and adding the same dispersing agent as the above dispersing agent.

3. The process for producing a polishing slurry according to claim 2, wherein the reduction ratio of the crystallite diameter in the abrasive particles caused by the dispersion of the abrasive particles of the polishing slurry liquid by the wet jet mill, is at most 10%.

4. The process for producing a polishing slurry according to claim 1, wherein the content of the dispersing agent in the polishing slurry liquid is from 0.1 to 5 mass %.

5. The process for producing a polishing slurry according to claim 2, wherein the content of the dispersing agent in the polishing slurry liquid is from 0.1 to 5 mass %.

6. The process for producing a polishing slurry according to claim 1, wherein the crystallite diameter of the abrasive particles in the polishing slurry liquid is from 5 to 100 nm.

7. The process for producing a polishing slurry according to claim 2, wherein the crystallite diameter of the abrasive particles in the polishing slurry liquid is from 5 to 100 nm.

8. The process for producing a polishing slurry according to claim 1, wherein the average primary particle size of the abrasive particles of the polishing slurry liquid is from 5 to 100 nm.

9. The process for producing a polishing slurry according to claim 2, wherein the average primary particle size of the abrasive particles of the polishing slurry liquid is from 5 to 100 nm.

10. The process for producing a polishing slurry according to claim 1, wherein the ratio of the average primary particle size to the crystallite diameter of the abrasive particles of the polishing slurry liquid is from 0.8 to 2.5.

11. The process for producing a polishing slurry according to claim 2, wherein the ratio of the average primary particle size to the crystallite diameter of the abrasive particles of the polishing slurry liquid is from 0.8 to 2.5.

12. The process for producing a polishing slurry according to claim 1, wherein the content of the dispersing agent added after the dispersion of the abrasive particles of the polishing slurry liquid by the wet jet mill, is from 0.01 to 2 mass % in the polishing slurry.

13. The process for producing a polishing slurry according to claim 2, wherein the content of the dispersing agent added after the dispersion of the abrasive particles of the polishing slurry liquid by the wet jet mill, is from 0.01 to 2 mass % in the polishing slurry.

14. The process for producing a polishing slurry according to claim 1, wherein the abrasive particles of the polishing slurry liquid is produced by a process comprising a step of obtaining a melt containing, as represented by mol % based on oxide, from 5 to 50% of CeO₂ or a mixture of CeO₂ and ZrO₂, from 10 to 50% of RO (R is at least one member selected from the group consisting of Mg, Ca, Sr and Ba), and from 30 to 75% of B₂O₃; a step of quenching the melt to obtain an amorphous material; a step of precipitating CeO₂ crystals or ceria-zirconia solid solution crystals from the amorphous material to obtain a crystallized product; and a step of separating the CeO₂ crystals or the ceria-zirconia solid solution crystals from the obtained crystallized product, in this order.

15. The process for producing a polishing slurry according to claim 2, wherein the abrasive particles of the polishing slurry liquid is produced by a process comprising a step of obtaining a melt containing, as represented by mol % based on oxide, from 5 to 50% of CeO₂ or a mixture of CeO₂ and ZrO₂, from 10 to 50% of RO (R is at least one member selected from the group consisting of Mg, Ca, Sr and Ba), and from 30 to 75% of B₂O₃; a step of quenching the melt to obtain an amorphous material; a step of precipitating CeO₂ crystals or ceria-zirconia solid solution crystals from the amorphous material to obtain a crystallized product; and a step of separating the CeO₂ crystals or the ceria-zirconia solid solution crystals from the obtained crystallized product, in this order.

16. A polishing slurry obtained by the process for producing a polishing slurry as defined in claim 1.

17. A polishing slurry obtained by the process for producing a polishing slurry as defined in claim 2.

18. The polishing slurry according to claim 16, wherein the content of the abrasive particles is from 0.1 to 40 mass %.

19. The polishing slurry according to claim 17, wherein the content of the abrasive particles is from 0.1 to 40 mass %.

20. The polishing slurry according to claim 16, which has a median diameter of from 10 to 300 nm.

21. The polishing slurry according to claim 17, which has a median diameter of from 10 to 300 nm.

22. A polishing method of polishing an object to be polished wherein a surface to be polished contains SiO₂, by using the polishing slurry as defined in claim 16.

23. A polishing method of polishing an object to be polished wherein a surface to be polished contains SiO₂, by using the polishing slurry as defined in claim 17.

24. The polishing method according to claim 22, wherein the ζ potential of the abrasive particles of the polishing slurry is positive, and the ζ potential of the object is negative.

25. The polishing method according to claim 23, wherein the ζ potential of the abrasive particles of the polishing slurry is positive, and the ζ potential of the object is negative.

26. A process for producing a glass substrate for a magnetic disk containing SiO₂, which uses the polishing method as defined in claim 22 for polishing of the principal plane of the glass substrate.

27. A process for producing a glass substrate for a magnetic disk containing SiO₂, which uses the polishing method as defined in claim 23 for polishing of the principal plane of the glass substrate.
